(19) United States
(12) Patent Application Publication
(10) Pub. No.: US 2013/0060932 A1
(43) Pub. Date: Mar. 7, 2013

(54) DISCOVERING TIERS WITHIN AN APPLICATION

(71) Applicants: Shachar Ofek, Ramat Gan (IL); Amichai Ungar, Bruchin (IL); Nick Ioffe, Bat Yam (IL)

(72) Inventors: Shachar Ofek, Ramat Gan (IL); Amichai Ungar, Bruchin (IL); Nick Ioffe, Bat Yam (IL)

(21) Appl. No.: 13/226,197

(22) Filed: Sep. 6, 2011

(51) Int. Cl. G06F 15/16

(52) U.S. Cl. 709/224

(57) ABSTRACT

A method for discovering tiers within an application includes monitoring network traffic. A periodic report may be assembled based on the network traffic. Tiers may be discovered using the periodic report.

### BACKGROUND

An enterprise application is software used by an organization that may reside on various tiers within a system infrastructure. Most often, an end user directly accesses only the front tier. Other tiers can be considered back end or middle tiers, and the end user does not communicate with those tiers directly. The back end or middle tiers are typically accessed only by servers within other tiers, such as the back end, middle, or front end tiers. For example, a front end tier can be a web application server that serves pages to an end user's computer. The web application server may communicate with a database server or an application server, which may represent a back end tier or a middle tier. The end user does not directly communicate with the database or application server, but the database or application server may communicate directly with other database or application servers.

Monitoring systems may be used to monitor computer networks or systems for components within different tiers that do not meet performance standards. As discussed herein, a component may refer to the physical hardware or a software module that gives some functionality to a computer system. In such a monitoring system, the customer may configure the monitoring system by defining the servers the customer wants to monitor. The definition provided by the customer may include the type of the traffic that is monitored, the internet protocol (IP) addresses of particular servers or tiers, certain ports on which to listen, and various other information. Typically, it is the responsibility of the customer to find the required configuration data and provide it to the monitoring system.

### BRIEF DESCRIPTION OF THE DRAWINGS

Certain exemplary embodiments are described in the following detailed description and in reference to the drawings, in which:

FIG. 1 is a process flow diagram showing a computer-executed method for discovering tiers within an application according to an embodiment;

FIG. 2 is a process flow diagram showing a computer-executed method for discovering tiers within an application according to an embodiment;

FIG. 3A is a block diagram of a system that may discover tiers within an application according to an embodiment;

FIG. 3B is a block diagram of a system that may discover tiers within an application according to an embodiment; and

FIG. 4 is a block diagram showing a non-transitory, computer-readable medium that stores code for discovering tiers within an application.

### DETAILED DESCRIPTION

The information used for a proper monitoring system configuration, including information regarding tiers of an application, is often not available to the person responsible for the deployment of such information. The person responsible for the deployment of such information may only have partial or erroneous information regarding the system. Moreover, in large organizations, even finding the person that may be responsible for the requested information can be challenging due to the size of the organization. Additionally, information such as IP addresses can change relatively frequently, and thus require frequent manual updates of the configuration.

Embodiments of the present techniques provide a system and method for discovering tiers within an application. Network traffic may be monitored, and a report may be assembled based on the network traffic. A map of the application's infrastructure can be built using the report, including discovered tiers. Embodiments of the present techniques may not be intrusive to the applications and may need little information from a user. The present techniques can also be used to assist in the deployment of products that install components on all the servers of an application. In an installation scenario, the customer often has a large number of servers with multiple tiers, complicating the task of identifying the relevant servers and tiers for a given application. Through the present techniques, the relevant servers and tiers may be discovered automatically. Further, the present techniques may be used to discover particular tiers for a security procedure on hosts that are related to the particular tiers.

Other embodiments of the present techniques allow monitoring of a number of applications, including all tiers within the applications, without having to know the deployment details of the applications. The customer merely supplies the application access point, which is typically the IP address or the universal resource locator (URL) used to access the application. The IP addresses of the front end applications may be easy to find, as end users of the applications use the IP addresses in order to access the applications.

A monitoring solution may consist of a probe and an engine. The probe may receive traffic from one of the customer's switches using port spanning, network taps, or any other suitable technique. Additionally, the probe may “sniff” all network traffic, including traffic in a data center, and between the tiers. Sniffing generally refers to a computer program or hardware that may intercept and log traffic passing over a digital network or part of a network. Further, the data center may be a location where an organization holds their computing operations. Traffic may include requests made by end users and responses generated by the data center servers.

The engine may receive data from the probe and build a map of an application's infrastructure. The probe may monitor the traffic in accordance with a configuration received from the engine or from another component, and then send various data to the engine for further processing. For ease of discussion, the architecture described herein includes a probe and an engine, and can be used in a monitoring solution. However, the probe and engine may be combined into one component, or their responsibilities described herein may be divided among a plurality of components or divided differently among a probe and an engine. Further, the present techniques may be used for various discovery solutions.

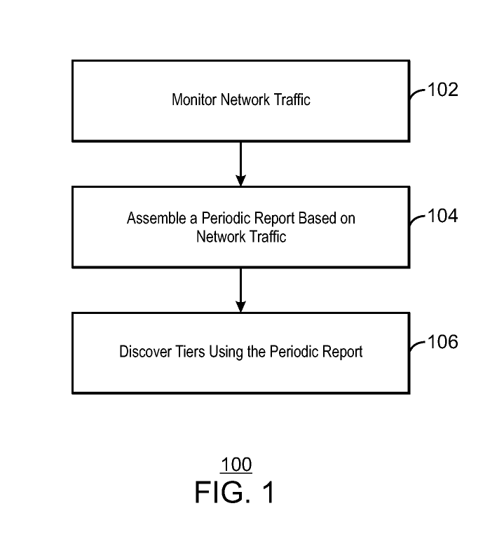

FIG. 1 is a process flow diagram 100 showing a computer-executed method for discovering tiers within an application according to an embodiment. At block 102, network traffic is monitored. At block 104, a periodic report may be assembled based on the network traffic. Each periodic report may be assembled by the probe after various intervals of time, or periods. The periodic reports may include information that identifies each tier, such as an address of a tier with incoming or outgoing network traffic. At block 106, tiers may be discovered using the periodic report. The engine may build a map of the application's infrastructure to discover tiers from the periodic report by aggregating the data from multiple periodic reports. For example, an assembled periodic report may contain a new source of network traffic that was not contained in a previous periodic report. As a result of not being contained in a previous periodic report, the new source of network traffic may not be built into the map of the application's infrastructure. The engine may aggregate data from the periodic report containing a new source of network traffic with data from previously assembled periodic reports, and add the new source of network traffic to the map of the application's infrastructure. A tier may be discovered at the new source of network traffic.

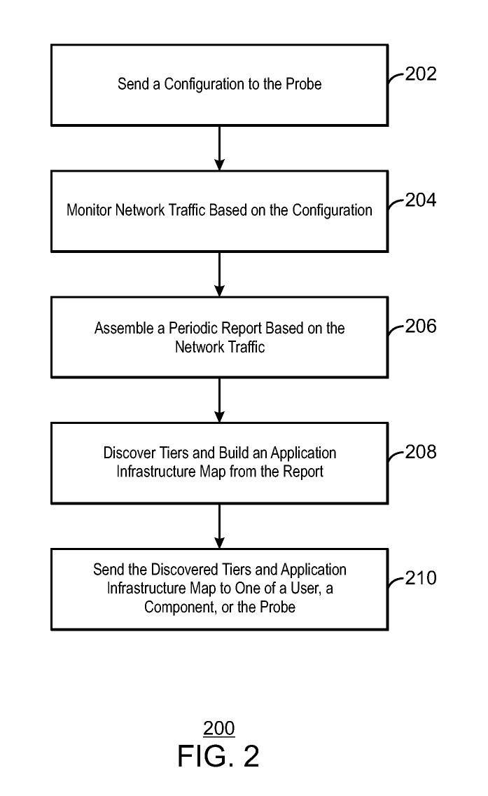

FIG. 2 is a process flow diagram 200 showing a computer-executed method for discovering tiers within an application according to an embodiment. At block 202, a configuration may be sent to the probe. The configuration may include data such as a list of tiers to monitor along with the IP address of each tier. Further, the configuration may be sent from the engine. The engine may also include in the configuration a request to monitor any discovered tiers.

At block 204, network traffic may be monitored based on the configuration. The probe can be used to monitor the network traffic based on the configuration. The probe may sniff all network traffic, or listen for all network traffic received from one of the customer's switches using techniques such as port spanning or network taps. The monitoring may be restricted to particular applications, servers, or tiers. In embodiments, the probe may listen to all outgoing traffic from those servers with tiers to be monitored in order to discover what services are used by the servers. Services may be defined as applications or various components that can be used by the servers. Additionally, network traffic may be monitored continuously and any discovered tiers can create new sources of network traffic to monitor continuously.

While the probe can monitor all traffic in the network, the amount of traffic can be quite large, and monitoring all traffic in the network can be expensive. A filter may be used to limit the amount of traffic that the probe monitors. Using the filter, the probe may monitor samples of the network traffic. Accordingly, in embodiments, the probe does not listen to all outgoing traffic at once. The probe may first listen to a sample of outgoing traffic from one server, then listen to a sample of outgoing traffic from another server. The probe can also filter the network traffic by the server port used. Incoming traffic may be filtered in a manner similar to outgoing traffic.

At block 206, a periodic report may be assembled based on the network traffic. The periodic report may be assembled by the probe, and the probe may include hosts that are not yet known within the periodic report. Additionally, the periodic report may include several other pieces of information, including, but not limited to, IP addresses, server ports, parent tier identifiers, and the protocol that is used in traffic. A parent tier identifier may be defined as an identifier of the tier whose server is the source of the traffic.

The protocol that is used in network traffic may contain data that is used for advanced monitoring, also referred to as protocol aware monitoring. Protocol aware monitoring may use advanced protocol techniques when monitoring servers, and refers to a network traffic monitor that is aware of the type of traffic being monitored, along with the semantics of this traffic. Such monitoring gives more than technical details on the traffic itself, but may also give some information on the content of the traffic. In embodiments, the data from protocol aware monitoring may be assembled in the report.

In order to obtain data from protocol aware monitoring to assemble within the report, the protocol of the traffic may be reverse engineered so that the details of the protocol can be obtained and included in the report. When reverse engineering the protocol of the traffic, the protocol itself is known or can be identified by the type of protocol used by a tier. Thus, the protocol may be identified by discovering new tiers, or the protocol can be defined by a user when the user identifies a tier, such as when a front end tier is identified by a URL. The protocol may also be identified by pattern matching within the network traffic. Pattern matching may identify protocols used in the network traffic based on the patterns throughout the network traffic.

At block 208, the tiers may be discovered and an application infrastructure map may be built from information within the periodic report. The probe may issue the assembled reports to an engine periodically, and the engine may aggregate the data contained within the periodic reports in order to discover tiers and determine what services are used by a particular server. While aggregating the data contained within the periodic report, the engine may also build a map of each application's infrastructure.

Accordingly, the engine is able to discover tiers or build an application infrastructure map by aggregating the data contained within the periodic report. For example, the IP addresses included in the periodic report may correspond to the destination server of each communication in the periodic report. Some destination servers may be hosts that are not yet known. While aggregating the data contained within the periodic reports, the engine may identify the IP addresses of unknown hosts as new tiers because the hosts were not previously discovered in another periodic report. The engine may also identify any problems with a specific type of query by aggregating the data from the periodic reports that are received from the probe. The data from protocol aware monitoring assembled in the periodic report can reveal a specific type of query to databases within the tiers that may deteriorate the performance of the database, which may not occur in other queries. Thus, the report may be used to identify database queries that cause deterioration in database performance from protocol aware monitoring data within the report. A deterioration in performance may include, but is not limited to, a reduction in speed, spikes in workloads, or relatively heavy workloads.

At block 210, the discovered tiers or application infrastructure map may be sent to one of a user, a component, or the probe. The engine may send the new tiers or the application infrastructure map to one of a user, a component, or the probe, and may also send an address of the discovered tiers to the probe with a request to monitor the discovered tiers. When the discovered tiers or application infrastructure map is sent to the probe, the probe may use the discovered tiers or application infrastructure map as a configuration. The probe may assemble a new periodic report including traffic that is outgoing from any host or server that it previously reported as a destination. The probe may also check and determine if the discovered tier is communicating with another tier that has not been discovered. Thus, the discovered tiers or application infrastructure map can then be sent to the probe as a configuration as at block 202. The configuration may include a definition of discovered tiers to be monitored in the same manner as any other tier. As a result of sending discovered tiers to the probe, network traffic may be monitored continuously and any discovered tiers can create new sources of network traffic to monitor continuously. Additionally, the discovered tiers or application infrastructure map can be reported to a user or any other component that may be interested in receiving notifications on the discovery of new tiers or application infrastructure.

Generally, tier discovery may be a service that notifies components upon discovery of a new tier. The response of tiers when discovered may be dependent upon the context in which the present techniques are used. For example, in a discovery solution, an application may simply alert the user that a tier was discovered, and then show information relative to the discovered tier. In a monitoring solution, the tiers may be monitored for any problems, and the problems may be tracked to their particular tiers.

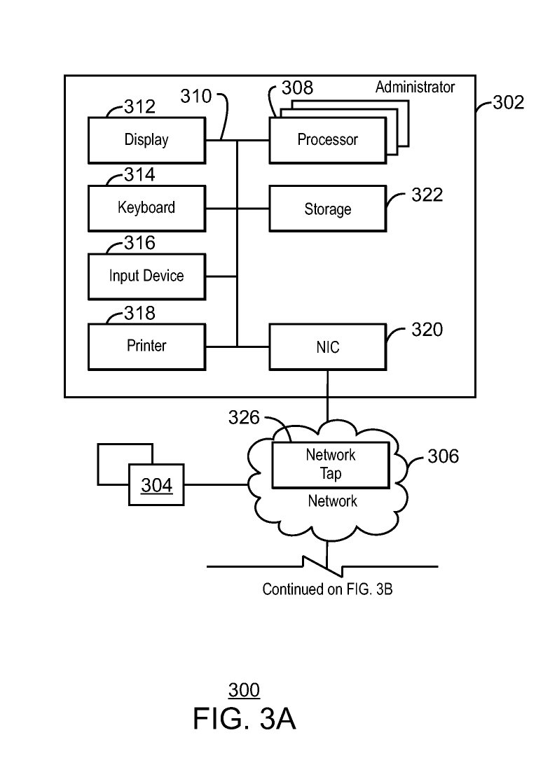

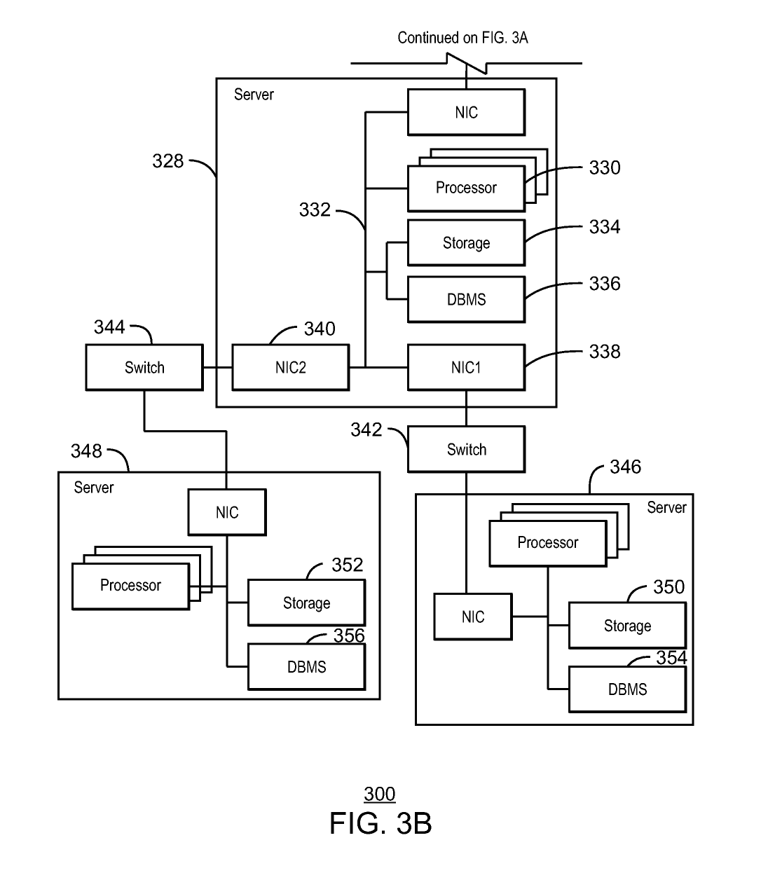

FIG. 3A is a block diagram of a system that may determine tiers of an application according to an embodiment. The system is generally referred to by the reference number 300. Those of ordinary skill in the art will appreciate that the functional blocks and devices shown in FIG. 3 may comprise hardware elements including circuitry, software elements including computer code stored on a tangible, a machine-readable medium, or a combination of both hardware and software elements. Additionally, the functional blocks and devices of the system 300 are but one example of functional blocks and devices that may be implemented in an embodiment. Those of ordinary skill in the art would readily be able to define specific functional blocks based on design considerations for a particular electronic device.

The system 300 may include an administrator computer 302, and one or more client computers 304, in communication over a network 306. As illustrated in FIG. 3, the administrator computer 302 may include one or more processors 308 which may be connected through a bus 310 to a display 312, a keyboard 314, one or more input devices 316, and an output device, such as a printer 318. The input devices 316 may include devices such as a mouse or touch screen. The processors 308 may include a single core, multiples cores, or a cluster of cores in a cloud computing architecture. The administrator computer 302 may also be connected through the bus 310 to a network interface card (NIC) 320, such as a multiple port interface card. The NIC 320 may connect the administrator computer 302 to the network 306.

The administrator computer 302 may have other units operatively coupled to the processor 308 through the bus 310. These units may include tangible, machine-readable storage media, such as storage 322. The storage 322 may include any combinations of hard drives, read-only memory (ROM), random access memory (RAM), RAM drives, flash drives, optical drives, cache memory, and the like. The storage 322 may include the data center, used in an embodiment of the present techniques to generate responses to requests made by end users. The data in storage 322 may be shared across the network 306.

The network 306 may be a local area network (LAN), a wide area network (WAN), or another network configuration. The network 306 may include routers, switches, modems, or any other kind of interface device used for interconnection. Through the network 306, several client computers 304 may connect to the administrator computer 302. The client computers 304 may be similarly structured as the administrator computer 302.

Network tap 326 may include a probe that accesses data flowing across the network 306. The network 306 may connect to several front, middle, and back end tiers. The network tap 326 may be used to filter the traffic that the probe monitors by the server port used. As a result, the probe may only monitor smaller portions of the network traffic at a time.

FIG. 3B is a block diagram of a system that may discover tiers within an application according to an embodiment. The system is a continuation of system 300 from FIG. 3A. The server 328 may include one or more processors 330 which may be connected through a bus 332 to a storage 334, a DBMS 336, a NIC1 338, and a NIC2 340. The processors 330 may include a single core, multiples cores, or a cluster of cores in a cloud computing architecture. NIC1 338 and NIC2 340 may connect the sever 328 to switch 342 and switch 344, respectively. Switch 342 and switch 344 may connect server 328 to server 346 and server 348, respectively. Server 328 may allow various applications to run from various servers in response to a request by an end user. The applications may reside on server 346 or server 348.

The present techniques may also be used in a multi-tier architecture, where the end user's computer represents the highest level, front end tier. For example, administrator computer 302 (FIG. 3A) or client computers 304 (FIG. 3A) may be an end user's computer. These computers may include a display 312, (FIG. 3A) where information from other middle and back end tiers may be displayed to the user.

Server 328 (FIG. 3B) may be a middle tier able to communicate directly to an end user's computer. The middle tier may contain, for example, logic that may process an end user's web page request, purchasing request, or search request. As a middle tier, server 328 may or may not contain a DBMS 336. Further, server 328, as a middle tier, may also communicate with other middle tiers or various back end tiers. Accordingly, the middle tier may make decisions or evaluate data from the front or back end tiers, as well as send information to the front or back end tiers.

Server 346 and server 348 may be back end tiers, which may communicate with the front end tier or the middle tier. The back end tiers may contain data in storage 350 and storage 352, which is maintained and organized by DBMS 354 and DMBS 356, respectively. For example, server 346 and server 348 may host various websites. Data requested from server 346 and server 348 may include various images and information associated with the website. Likewise, in a purchasing context, server 346 and server 348, as back end tiers, may contain information related to inventory and availability of several products in a data center. Finally, in a searching context, server 346 and server 348 may contain databases of information to be searched when functioning as back end tiers. For ease of description, one middle server and two back end servers are described, but, the present techniques may be used with any number of servers and tiers, and are not limited to the embodiments described.

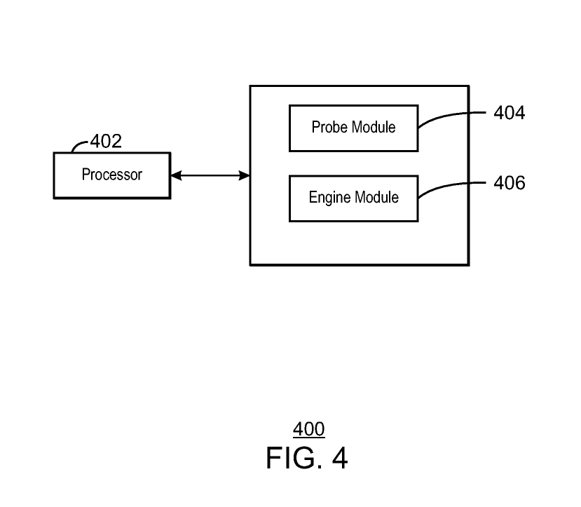

FIG. 4 is a block diagram showing a non-transitory, computer-readable medium that stores code for discovering tiers within an application. The non-transitory, computer-readable medium is generally referred to by the reference number 400.

The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 402 generally retrieves and executes the computer-implemented instructions stored in the non-transitory, computer-readable medium 400 for discovering tiers within an application. At block 404, a probe module may provide code instructing a processor to monitor network traffic. The probe module may also assemble periodic report information based on the network traffic. At block 406, an engine module may discover tiers using the periodic report information from the probe module. The engine module may also build a map of the application's infrastructure, including the discovered tiers.

What is claimed is:

1. A system for discovering tiers of an application, comprising a memory device and a processor adapted to execute instructions stored on the memory device, wherein the memory device stores instructions that when executed cause the processor to:
monitor network traffic;
assemble a periodic report based on network traffic; and
discover tiers using the periodic report.

2. The system recited in claim 1, wherein the memory device stores instructions that when executed cause the processor to identify database queries that cause deterioration in database performance from protocol aware monitoring data within the report.

3. The system recited in claim 1, wherein the memory device stores instructions that when executed cause the processor to limit the amount of network traffic monitored.

4. The system recited in claim 1, wherein the memory device stores instructions that when executed cause the processor to aggregate data from several periodic reports to discover tiers or build a map of the application's infrastructure.

5. The system recited in claim 1, wherein the memory device stores instructions that when executed cause the processor to monitor the discovered tiers.

6. The system recited in claim 1, wherein the memory device stores instructions that when executed cause the processor to use the discovered tiers or an application infrastructure map as a configuration to monitor network traffic.

7. The system recited in claim 1, wherein the memory device stores instructions that when executed cause the processor to send the discovered tiers or an application infrastructure map to one of a user, a component, or a probe with a request to monitor the discovered tiers.

8. A method for discovering tiers within an application, comprising, comprising:
monitoring network traffic;
assembling a periodic report based on network traffic; and
discovering tiers using the periodic report.

9. The method recited in claim 8, wherein a protocol is reverse engineered to include details of the protocol in the report.

10. The method recited in claim 8, comprising limiting the amount of network traffic monitored.

11. The method recited in claim 8, wherein the network traffic is monitored continuously and the discovered tiers create new sources of network traffic to monitor continuously.

12. The method recited in claim 8, comprising aggregating data from several periodic reports to discover tiers or build a map of the application's infrastructure.

13. The method recited in claim 8, comprising using the discovered tiers or an application infrastructure map as a configuration to monitor network traffic.

14. The method recited in claim 8, comprising sending the discovered tiers or an application infrastructure map to one of a user, a component, or a probe with a request to monitor the discovered tiers.

15. A non-transitory, computer-readable medium, comprising code configured to direct a processor to:
monitor network traffic using a probe module;
assemble a periodic report based on network traffic using the probe module; and
discover tiers with the periodic report using an engine module.

16. The non-transitory, computer-readable medium of claim 15, comprising identifying database queries that cause deterioration in database performance from protocol aware monitoring data within the report.

17. The non-transitory, computer-readable medium of claim 15, comprising using a filter to limit the amount of network traffic monitored.

18. The non-transitory, computer-readable medium of claim 15, comprising aggregating data from several periodic reports to discover tiers or build a map of the application's infrastructure.

19. The non-transitory, computer-readable medium of claim 15, comprising using the discovered tiers or an application infrastructure map as a configuration to monitor network traffic.

20. The non-transitory, computer-readable medium of claim 15, comprising sending the discovered tiers or an application infrastructure map to one of a user, a component, or a probe with a request to monitor the discovered tiers.
